(19) United States
(12) Patent Application Publication
(10) Pub. No.: US 2011/0050150 A1
(43) Pub. Date: Mar. 3, 2011

(54) ELECTRIC MOTOR

(76) Inventor: Magnus Lindmark Lilliestrale, Stockholm (SE)

(21) Appl. No.: 12/863,342

(22) PCT Filed: Jan. 18, 2008
(86) PCT No.: PCT/SE2009/000017

§ 371 Date: Jul. 16, 2010

(30) Foreign Application Priority Data
Jan. 18, 2008 (SE) 0800124-0
Jul. 25, 2008 (SE) 0801732-9

(51) Int. Cl. H02P 6/08

(52) U.S. Cl. 318/716

(57) ABSTRACT

The present invention relates to a device for controlling the speed of an electric motor, wherein the said motor is arranged to be connected to a voltage source, wherein the said motor comprises a stator winding and a rotor winding, wherein, in operation, a rotating stator field having a first rotational frequency is generated in the stator winding, wherein the said stator field, in operation, is arranged to induce a first rotor field having a second rotational frequency in the said rotor winding. The device comprises frequency converter means for generating a second rotor voltage having a third rotational frequency from a voltage in the rotor winding being induced from the said stator field, for being supplied to the said rotor winding, wherein the said second rotor voltage being generated by the said frequency converter, in operation, is arranged to generate a second rotating rotor field in the said rotor winding so that, in operation, the rotor rotates with a rotational frequency substantially being the difference between the rotational frequency of the stator field and the rotational frequency of the generated second rotor field.

### FIELD OF THE INVENTION

The present invention relates to devices for controlling the speed of a motor, such as, for example, a three-phase motor, and in particular to a device for controlling the speed of a motor according to the preamble of claim 1. The invention also relates to a method according to claim 20, an electric motor according to claim 21 and a generator according to claim 22.

### BACKGROUND OF THE INVENTION

Electric motors are very common in today's society. In particular single-phase and three-phase motors belong to the most common electric motors, and together these single-phase and, in particular, three-phase motors also constitute large electricity consumers.

Today, the most common embodiment of three-phase motors is the so-called induction motor, wherein the rotor is manufactured in a squirrel-cage design. The theoretical no-load speed of the induction motor is determined by the frequency of the power supply and number of poles, and when the motor is loaded there is a reduction in speed. The reduction in speed gives rise to a difference in the angular velocity between the rotating stator field, which is rotating with a speed being synchronous to the feeding power distribution network, and the rotor shaft. This difference in angular velocity is referred to as slip, which gives rise to a current induction in the conductors of the rotor. The current in the rotor winding, together with the rotating air gap flux, gives rise to a mechanical torque on the rotor, which increases with increasing slip. The slip, however, is small in comparison to the no-load speed of the motor during normal operation, the speed of the three-phase motor thus being substantially constant.

Often times, however, there is a desire from users of these motors that the motor speed should be controllable, e.g. in order to save energy or in order to control the speed of a device being driven by the motor, such as, e.g. a fan, a pump or some kind of conveyor belt.

Although being robust and simple in its design, the speed of the squirrel-cage induction motor cannot be accomplished in a relatively lossless manner other than by simultaneously changing both supply voltage and supply frequency. The reason for this is that the magnetisation of the motor arises from the currents through the stator winding. The current through the stator winding is, in no-load operation, determined by the voltage and frequency that the motor is connected to. In order to maintain the same magnetisation of the motor when changing the frequency of the stator voltage, the voltage must also by changed in the same proportion.

Therefore, in case there is a desire to variably control the speed of the motor, a frequency converter is, in general, connected between motor and power distribution network. At the beginning of speed-control, prior to suitable controllable electric valves being available, a common solution to controlling the speed of a three-phase motor was use of a slip ring three-phase motor. An example of such speed control is shown in FIG. 2, wherein the illustrated motor 200 comprises a rotor 201, the three-phase winding of which being connected to three slip rings 202-204 arranged on the motor shaft 205. Brushes 206-208 rest on each slip ring and are, in turn, connected to a resistor R1, R2, R3, respectively. In case the rotor (motor) shaft 205 has a low speed, the difference between the speed of the rotating stator field, rotating synchronously to the power distribution network, and the speed of the rotor is large. This results in a relatively high frequency and voltage between the slip rings. The current drawn off by means of the slip rings is fed to variable resistors R1-R3, wherein a change in resistance of the resistors R1-R3 has as result that the current through the rotor winding is changed. A low value of R1-R3 results in a higher rotor current. A higher current in the rotor winding results in an increase of the torque of the rotor shaft.

The motor torque or speed can now be controlled by changing the resistance of the resistors. In practice, however, this method is no longer used to control the speed of a motor, mainly due to large heat losses in the resistors, with a low efficiency as result. The disclosed method has mainly come to use when starting larger motors so as to obtain a high starting torque while simultaneously reducing start current drawn from the power distribution network.

FIG. 3 discloses an alternative method of speed control using slip rings where losses are reduced. In the solution shown in FIG. 3 the slip ring voltage is rectified instead of feeding the rotor winding currents through resistors. The rectified voltage is then used to feed a network commutated frequency converter via a smoothing reactor L. In this way the slip ring power can be fed back into a power distribution network, which drastically reduces losses when controlling the speed.

As was mentioned, slip ring solutions are no longer used to any greater extent, but a frequency converter is in general used instead, which is connected between motor and power distribution network when motor speed control is desired.

FIG. 1 discloses an example of current frequency converters, where the power distribution network voltage (in the figure is shown a three-phase voltage having phases R, S, T) is first rectified using diodes 101-106 in order to obtain a DC intermediate voltage which charges a capacitor CK. A three-phase voltage having a desired frequency is then generated by means of a converter circuit consisting of electrically controllable semiconductor valves 107-112, which is connected to the capacitor CK. The six electrical valves 107-112 receives control pulses from a controllable control oscillator VFO 120, whereby control pulses a, b, c, d, e, f from the VFO opens and/or closes the electrical valves 107-112 in a desired manner.

An anti-parallel diode 113-118, respectively, can also be connected to each valve in order to provide a path for inductive load currents in the reverse direction.

The control pulses from the oscillator are generated in such a manner that, e.g. by pulse width modulation, PWM, a new three-phase voltage (U, V, W) having a certain frequency and voltage is created. The frequency and amplitude of the voltage (U, V, W) can be arranged to follow each other (for the above described reason) in such a manner that if the frequency is reduced, the voltage is reduced as well.

According to the above the speed of a squirrel-cage three-phase induction motor is determined by the frequency of the power distribution network voltage, and by changing frequency and voltage of (U, V, W), using the semiconductor valves 107-112, the motor 130 can thus be speed controlled. This control can, in principle, be used to operate the motor at an arbitrary speed, where the frequency, and thereby motor speed, using suitable control pulses to the valves 107-112, can be arranged to vary from 0 Hz (non-rotating motor) to, in principle, an arbitrary speed, i.e. also speeds corresponding to frequencies that exceed the frequency of the power distribution network. Current frequency converters, however, have drawbacks. According to FIG. 1 the voltage of the power distribution network is rectified and charges the capacitor CK. This kind of rectification often gives rise to undesired current peaks and harmonics in the power distribution network, and also has the result that the power factor of the power distribution network becomes poor unless expensive filter arrangements are used between converter and the power distribution network. The valves usually utilize pulse width modulation (PWM) when creating the new output voltage. This method requires that rise and fall times of the electrical valves are short in order to minimize losses in the valves, but this gives rise to high-frequency harmonics which radiate from cables and propagates into the power distribution network since the frequency converter is not galvanically isolated from the power distribution network. These distortions can cause large problems for other equipment.

Today, the level of these distortions is often controlled by government regulations, and in order to overcome these distortions expensive and space requiring filter arrangements are usually required.

Another drawback of current frequency converters is that larger motors sometimes are power supplied by high voltages, i.e. considerable higher voltages than usually is available in power distribution networks for households. Since current semiconductor valves have limited capabilities when it comes to the withstanding of voltage, they can only be used if the voltage to the converter is first reduced and then transformed to a higher voltage after the converter for supply to the motor, which results in a more costly and space-requiring solution. Alternatively, plural converters can be series connected in order to cope with a higher voltage, which also results in an expensive and space-requiring solution.

Consequently, there exists a need for a variable speed controllable motor that does not exhibit the drawbacks of motors utilizing power distribution network connected frequency converters, and that can also be speed controlled in a simpler and more cost efficient manner as compared to current solutions so as to make speed control and associated energy saving possibilities more available.

### SUMMARY OF THE INVENTION

It is an object of the present invention to provide a device for controlling the speed of a motor that solves the above mentioned problem.

This and other objects are obtained according to the present invention by means of a device for controlling the speed of an electric motor, wherein the said motor is arranged to be connected to a voltage source, e.g. a three-phase voltage source, wherein the said motor comprises a stator winding and a rotor winding, such as, e.g., a three-phase rotor winding, wherein the stator winding, in operation, generates a rotating stator field having a first rotational frequency, wherein the said stator field, in operation, is arranged to induce a first rotor field having a second rotational frequency in the said rotor winding, which can be the same as the said first rotational frequency. The device comprises a frequency converter in order to generate a second rotor voltage, e.g. a three-phase voltage from a voltage in the rotor winding being induced from the said stator field having a third rotational frequency for being supplied to the said rotor winding.

The said second rotor voltage being generated by means of the said device generates, in operation, a second rotating rotor field in the said rotor winding so that, in operation, the rotor rotates with a rotational frequency substantially being the difference between the rotational frequency of the stator field and the rotational frequency of the generated second rotor field.

The said second rotor field can be a rotor field rotating in the same direction as the said stator field.

This has the advantage that the generated second rotor voltage, such as e.g. a three-phase voltage, will function as magnetisation of the rotor and stator to various extent, while at the same time the rotor is brought to rotation by means of a variable rotational frequency while the second rotor voltage being supplied to the rotor winding causes the three-phase motor to work synchronous with the difference between the rotational frequency of the stator field and the rotational frequency of the supplied second rotor field. The speed of the motor can be controlled by varying the frequency of the generated three-phase voltage being supplied to the rotor. If a voltage having a frequency corresponding to the frequency of the stator field is supplied to the rotor winding, the motor will essentially be standing still, while if the supplied frequency is low this will result in the motor (rotor) rotating with a speed close to the rated speed of the motor, at least for as long as the rotor is being magnetised.

Since the rotor field, in operation, will rotate synchronously with the stator field (as seen from the stator), power being delivered from the rotor, in the form of active power and also reactive power, can be fed back to the power distribution network via the stator irrespective of the speed of the motor. This, in turn, has the advantage that power can be fed back in a system wherein the frequency converter is galvanically isolated from the power distribution network. This can reduce harmonics, current peaks and radio distortion to a great extent, which in turn reduces the requirements of expensive filters as result. Speed control of an electric motor such as a three-phase motor can thus be obtained in a simple and cost efficient manner, which in turn allows for energy saving when using such motors in, e.g. pumps, fans etc., wherein speed control is desired but often not economically motivated.

In one embodiment of the present invention a dual frequency converter is used in order to generate two separate voltages, which are supplied to respective ends of the said rotor winding.

The invention also relates to a motor, a method and a generator.

### BRIEF DESCRIPTION OF THE DRAWINGS

FIG. 1 shows a prior art speed control device for a squirrel-cage three-phase motor with a frequency converter.

FIG. 2 shows a prior art speed control device for a slip ring three-phase motor having variable resistors in the rotor circuit.

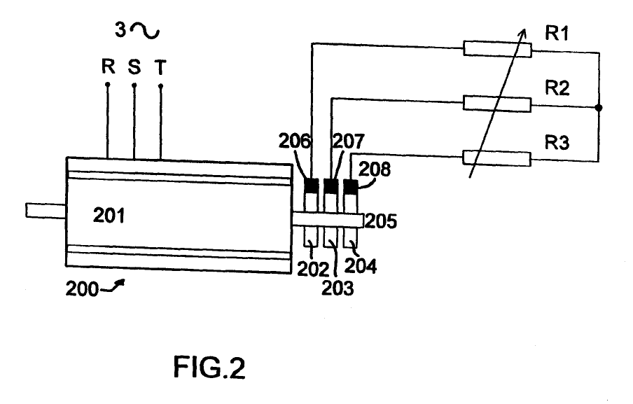

FIG. 3 shows a prior art speed control device for a slip ring three-phase motor wherein slip ring power is fed back to the power distribution network.

FIG. 4 shows a first exemplary embodiment of a device for speed control of a three-phase motor according to the invention, having a dual frequency converter.

FIG. 5 shows a switch period of a dual frequency converter when feeding a rotor winding according to the invention.

FIG. 6 shows voltage outputs from a dual frequency converter being connected to one side, respectively, of a rotor winding according to the invention.

FIG. 7 shows an alternative exemplary embodiment of a device for speed control of a three-phase motor according to the invention.

FIG. 8 shows an alternative exemplary embodiment of a device for speed control of a single phase motor according to the invention.

### DETAILED DESCRIPTION OF PREFERRED EMBODIMENTS

As was mentioned above, speed control of a three-phase motor has mainly been accomplished by either taking out rotor power via slip rings for burning the power as heat, or feeding the power take out to a power distribution network, or by connecting a frequency converter between the power distribution network and the motor. As was also mentioned above these solutions have various drawbacks.

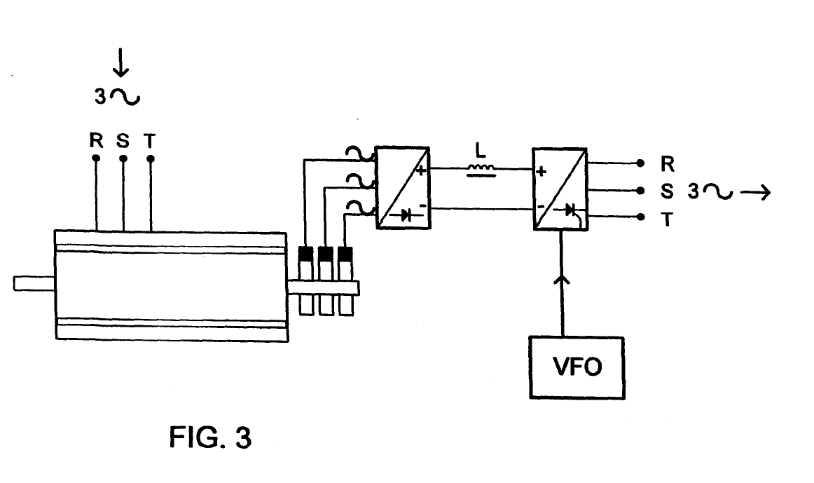

When using a slip ring three-phase motor, the power from the rotor that must be taken care of increases, according to the above, with decreasing rotor rotational speed, i.e. the slower the rotor is allowed to rotate in relation to the rotational speed of the stator field, the larger is the power that is fed to the slip rings in relation to the power being fed to the motor shaft. In the prior art device shown in FIG. 3, the rotor power is fed back to the power distribution network according to the above. This device has the drawback that the frequency converter that is required to feed back power to the power distribution network will be galvanically connected to the power distribution network which, as described above, gives rise to undesired current peaks and harmonics that propagate into the power distribution network, which thus can lead to demands for expensive filter arrangements in order to cope with the distortions. Slip rings and brushes also require expensive maintenance. Alternatively, the surplus power must be burned by resistors, which results in a very low efficiency unless the surplus heat somehow can be taken care of and be used.

A solution in which a converter is connected between the power distribution network and motor results in a space-requiring solution which has problems with harmonics being fed back to the power distribution network, and the power factor of the motor being poor.

According to the present invention these problems are solved, or at least mitigated.

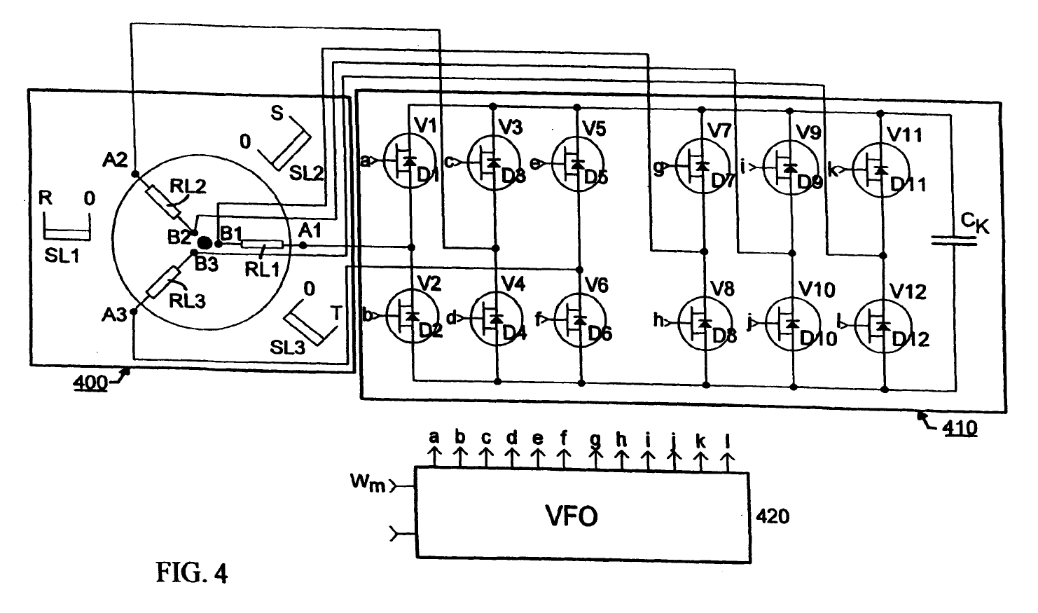

In FIG. 4 is shown a first exemplary embodiment of the invention. The figure schematically shows a 2-pole three-phase motor 400 having a wound rotor. The motor 400 comprises a stator winding consisting of three-phase windings SL1, SL2, SL3 (in this description and the appended claims the term winding is used in singular in order to denote e.g. a three-phase winding even if the three-phase winding in practice consists of three separate windings, one for each phase), which are substantially sinusoidally distributed and symmetrically arranged with 120° mutual phase displacement in angular space. As is well known in the art, when feeding the phase windings with sinusoidal voltages being 120° mutually phase shifted in time (i.e. a conventional three-phase system), a rotating field having synchronous speed and constant amplitude is obtained in the stator.

The rotor of the disclosed motor is a wound rotor, and the rotor thus comprises a rotor winding consisting of three phase windings RL1, RL2, RL3 which also are substantially sinusoidal and symmetrically arranged with 120° mutual phase displacement in angular space.

When the disclosed motor is connected to the power distribution network, the rotating stator field being generated in the stator will induce alternating voltages in the rotor winding, whereby this alternating voltage can drive current through the rotor winding. For as long as the rotor phase windings do not conduct any current, however, no torque will be obtained, the only thing that will happen is that the flux waves rotates around and through the rotor phase windings while the rotor is standing still. The amplitude of the voltage being induced in the rotor winding depends on the particular winding of the rotor. If the rotor winding comprises an equal number of turns as the stator winding, the rotor voltage will correspond to the stator voltage, i.e. the power supply voltage if the motor is not rotating. If the rotor winding, for example, has half the number of turns, a voltage of half the amplitude of the stator voltage will be induced, all according to classical transformer theory. A torque will arise on the rotor when current flow through the rotor winding by means of interaction with the stator flux wave, which torque will strive to bring the rotor into rotation in the rotational direction of the stator flux. With regard to the magnetisation of the motor, in this case, the current through the stator winding will give rise to a magnetic flux in the stator core. Since the stator core from a flux point of view is series connected to the rotor core, a magnetic flux in the stator will also have as a result that a magnetic flux passes through the rotor, i.e. the motor can be magnetised by a magnetic flux irrespective of whether this arises in stator or rotor.

As was mentioned above, a motor of this kind can be speed controlled according to the prior art by changing the frequency of the voltage being connected to the stator winding, alternatively by taking out and controlling rotor currents via slip rings.

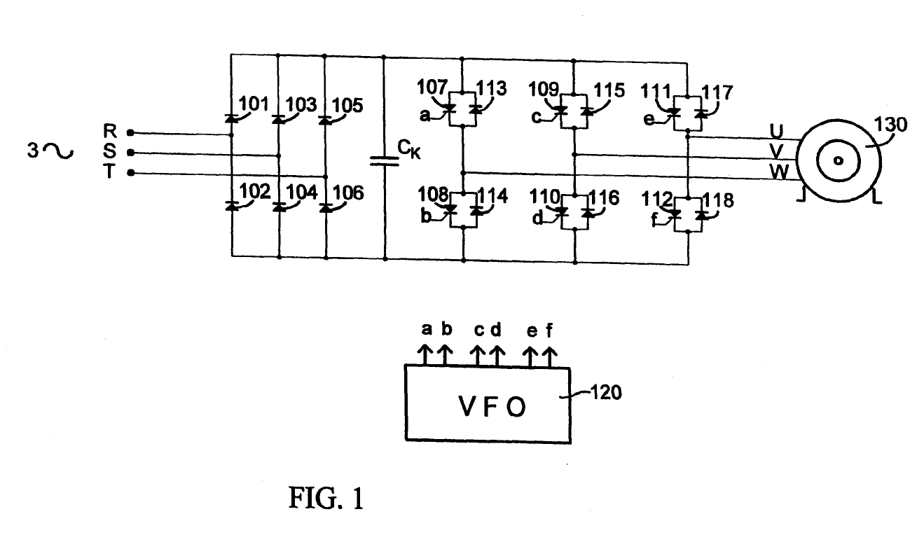

According to the present invention, speed control is, as in the case with a slip ring solution, carried out on the rotor side, however without taking out the rotor currents externally, i.e. there is no need for slip rings. Instead, each end A1, B1; A2, B2; A3, B3 of the rotor phase windings RL1, RL2, RL3 is connected to a dual frequency converter 410 consisting of two frequency converters, wherein each frequency converter is similar to the one shown in FIG. 1 and consists of six electrical valves V1-V6 and V7-12, respectively, such as e.g. IGBT transistors. The valves V1-V12 also have anti-parallel diode functionality, indicated by D1-D12. The flux wave that is generated by the stator winding induces a voltage over the rotor winding, which is rectified via the anti-parallel diodes D1-D12 and creates a direct-current voltage over a capacitor CK.

The dual frequency converter 410 then converts, by means of valves V1-V6 and V7-V12, respectively, and the diodes, the direct-current voltage over the capacitor CK into two three-phase voltages, respectively, the frequencies of which being settable by means of control electronic VFO 420 in FIG. 4, which, e.g. by means of pulse with modulation (PWM) in a manner known per se generates a PWM pattern that results in two sinusoidal fundamental tones of a desired frequency. The switch frequency being used for generating the sinusoidal fundamental tone in motor applications is usually between 2 kHz and 40 kHz, but other switch frequencies can also be used. First assume that one half of the dual frequency converter generates a voltage that is 180 degrees out of phase from the second half. This means that the voltage over e.g. rotor phase winding RL1 will reach a peak value of max Uck. In a manner corresponding to what has been described in connection with FIG. 1 the twelve electrical valves V1-V12 receives control pulses from a controllable control oscillator VFO 420, where control pulses a, b, c, d, e, f and g, h, i, j, k, l from VFO 420 opens and/or closes the electrical valves with a high frequency in a desired manner so that each respective pair of valves generates a sinusoidally shaped voltage being connected to a respective end of a rotor phase winding and thereby gives rise to a sinusoidal current in the winding.

In order to describe the function more in detail it is assumed that the stator is connected to a power distribution network having a frequency of 50 Hz. The rotor voltage being induced in the rotor winding will also have the frequency 50 Hz if the rotor is standing still. A charging of the capacitor CK to a voltage being determined by the rotor voltage (rotor winding) will then occur by means of the diodes in the frequency converter. If the frequency of the voltage being generated by each frequency converter is kept at 50 Hz, and the phase sequence is the same as the phase sequence of the power supply, the voltage over CK converted by the dual frequency converter generates a rotating field having the same rotational direction and speed as the field generated by the stator voltage, i.e. two synchronously rotating flux waves is obtained. For exemplary purposes the rotational direction is assumed to be counter-clockwise in the figure. If the peaks of the two flux waves are overlapping, north pole to south pole, there is no interaction between the flux waves that gives rise to a torque and the rotor stands still. The magnetisation of stator and rotor that is required for the flux is generated by a magnetisation current, partly from the power distribution network and partly from the frequency converter. Magnetisation in conventional induction motors occurs by a reactive magnetisation current being taken out from the power distribution network. This magnetisation power, which is mainly inductive reactive, constitutes a large portion of the total power (the sum of the reactive power and the active power) that constitutes the load imposed by the motor on the power distribution network. The motor according to the invention will be magnetised also by means of the power that is taken out from the frequency converter. The magnetisation provided by the frequency converter is mainly capacitive reactive, as seen from the stator.

If the frequency of the voltage of the converter is successively reduced and the rotor can rotate freely, the rotor is caused to rotate counter-clockwise by means of the generated torque with a speed that corresponds to the difference between frequency of the power distribution network and the rotor frequency being generated by the frequency converter. The peak of the flux wave in the stator and the peak of the flux wave in the rotor will no longer be on top of each other, but will have a certain angle with respect to each other. This angle is called torque angle and constitutes the basis for the generation of a torque on the motor shaft by means of magnetic interaction. In principle, the function according to the present invention can be described according to the following. If the stator field rotates with 50 Hz and a rotor field having the same rotational direction of the stator field of, e.g., 30 Hz is generated by the frequency converter 410, the stator field as “seen” from the rotor will be 50 Hz-30 Hz, i.e. 20 Hz, which is why the rotational speed of the rotor will be 20 Hz since the field generated by the frequency converter causes the motor to function as if, in a conventional synchronous motor, the stator was fed with 30 Hz.

When, in operation, the motor is loaded, the same thing occurs as when the motor shaft is standing still. By means of interaction between the flux wave that is rotating synchronously with the power distribution network and the flux wave that is rotating synchronously with the frequency converter, a torque is obtained which corresponds to the load torque. The electrical power that corresponds to the mechanical power is supplied to the stator winding from the power distribution network, and the dual frequency converter, which feeds the rotor winding, is loaded substantially by reactive current.

When the motor according to the invention is subjected to a load it can, running with constant speed, at most be braked (loaded) by a certain torque if continued synchronous operation is to be maintained. If this torque is exceeded, the torque angle between the two poles of the two flux waves becomes too large, whereby the motor falls out of “synchronism” (note that the motor does not work in synchronism with the stator field but in synchronism with the difference field) and starts to accelerate in order to work asynchronously as a conventional induction motor.

This can, however, be avoided in a simple manner, e.g. by arranging a position sensor on the motor shaft, whereby the frequency being generated by the electrical valves are controlled from the VFO which in turn is influenced by signals from the position sensor in order to prevent the motor from falling out of synchronism. That is, if the load becomes too large the speed of the motor can be adapted such that the load at all times is within the limit for maintaining a synchronously working system.

Consequently, the present invention has the advantage that a three-phase motor can be speed controlled in a simple manner, wherein the components being necessary for the speed control can be assembled together with the rotor and/or rotor shaft so as to provide a solution that is very reliable from a functional point of view since no galvanic contact between rotating and non-rotating parts is required. This further has the advantage that transfer to the power distribution network of harmonics being generated when rectifying and inverting voltages can be reduced to a large extent.

The control information to the VFO can be transferred by means of any known system being used today. For example, the transmission system can consist of a system based on optical, radio and/or ultrasonic technologies.

Since the motor works in a synchronous manner power can also be fed back to the power distribution network since the rotor (the flux wave of the rotor) as seen from the stator rotates synchronously with the same frequency as the frequency of the power distribution network, that is, the poles of the two flux waves are in a constant position in relation to each other.

This means that the motor according to the present invention can also function as generator, which in turn means that if the motor instead of driving its load is being driven by its “load” it can work in generator mode at an arbitrary speed and still feed generated power to a power distribution network being connected to the stator. In this case the frequency converter can be used to generate a second rotor voltage from an induced voltage in the rotor winding, the induced voltage being generated by rotation of the rotor by means of the load, such that the stator field in operation rotates with a rotational frequency substantially corresponding to the sum of the rotational frequency of the rotor and the rotational frequency of the second rotor field being generated from the second rotor voltage, which thereby allows that the rotor of the generator can rotate at a slower speed and still feed power to a power distribution network having a higher frequency than the rotational frequency of the rotor.

So far only subsynchronous motor operation has been discussed, that is, the motor is operated with a rotor rotating slower than “normal” synchronous speed. The machine according to the present invention, however, can also be used for oversynchronous motor operation, that is, motor operation wherein the rotor rotates faster than “normal” synchronous speed. The machine can also be used for both oversynchronous and subsynchronous generator operation, respectively.

In subsynchronous generator operation, however, the voltage over capacitor CK will not be maintained by current from the converter. Therefore, in order to be able to use the machine as generator in subsynchronous generator operation, it is required that the capacitor CK is supplied with current externally so as to ensure that the voltage over CK does not reach such low levels than magnetisation of the rotor is at risk. The amount of power to be supplied to CK depends on the speed of the rotor.

The reason for this is that since the converter receives its feed from CK, the voltage over CK will not be enough to magnetise the rotor to such extent that it is possible to load the rotor with full torque.

If it is desired to run the machine in subsynchronous generator operation energy must therefore be supplied to the capacitor CK. This can, for example, be accomplished by means of coils which are connected to the capacitor CK via rectifiers. These coils are positioned on a suitable location of the motor shaft, and when the motor shaft rotates these coils are arranged to pass magnets attached to the motor housing. The magnets will then, in a well known manner, induce an alternating voltage over the coils, whereby the induced alternating voltage is rectified to charge CK. The induction can be enhanced by arranging a magnetically conducting material inside the coils.

If, on the other hand, the generator is operated in oversynchronous operation, that is, the generator is being driven by its load in such a manner that the rotor rotates with the same or higher frequency than the stator frequency, the voltage will, similar to the situation of subsynchronous motor operation, be maintained by current from the converter and no external energy supply is required.

At oversynchronous generator operation the frequency converter is controlled in such a manner that the second rotor voltage that is generated by the frequency converter just as above generates a second rotating rotor field in the said rotor winding, however with the rotational direction being opposite to the said first rotor field. Consequently, this means that, for example, a rotor rotational frequency of 60 Hz and a second rotor field of 10 Hz in the opposite direction will result in a stator rotation frequency of 60+(−10)=50 Hz (this is valid for a 2-pole machine. For other pole numbers the pole number must, of course, be taken into consideration in a conventional manner. This is valid throughout this description. If, for example, the machine is a 4-pole machine the rotor will rotate oversynchronously already at a rotor rotation frequency exceeding 25 Hz (for a stator frequency of 50 Hz).

If the machine is to be used for near synchronous speed operation, or operation where the shaft rotates synchronously with the stator field, or for oversynchronous motor operation, it is required, as in subsynchronous generator operation and for the same reason, to supply charge to CK. A second rotor field being opposite to the first rotor field is generated also in oversynchronous motor operation, i.e. similar to oversynchronous generator operation.

With regard to cos Φ towards the power distribution network of the motor and the generator, respectively, in the above different operation alternatives, cos Φ will, in principle, with regard to oversynchronous motor operation and subsynchronous generator operation, mainly be affected by the external current being fed to CK. The voltage over CK determines the size of the magnetisation.

With regard to oversynchronous generator operation the situation is opposite to subsynchronous motor operation, i.e. the capacitively reactive power that the power distribution network is subjected to by the generator will increase if the phase shift is reduced. A reduction of the phase shift between the converter portions (this phase angle will be explained more in detail below) will thus, opposite to the case where the motor is subsynchronously operated, increase the capacitively reactive power that is fed to the power distribution network.

The present invention, therefore, has the advantage that when the motor runs at a lower speed, lower than the rotational speed of the power distribution network, the motor will operate system synchronously and the power from the dual frequency converter being delivered by the rotor winding is being delivered without galvanic contact between frequency converter and power distribution network.

As was mentioned above, motors of today load the power distribution network with reactive power. This reactive power does not perform any usable work, but gives rise, instead, to losses in the motor and losses in the power distribution network that the motor is being connected to. Due to the general use of three-phase motors in society, three-phase motors having cos Φ=1, and thereby better efficiency than today, would have a large impact on the energy use of the society. An advantage of the motor shown in FIG. 4 is that cos Φ, that is, the motor power factor, can be controlled. The reactive power can either be capacitive or inductive. In the above described motor the reactive power is mainly capacitive if the motor runs subsynchronously and if both outputs from the dual frequency converter, as was mentioned, is 180° out of phase from each other, that is, the voltage over the rotor winding is at a maximum and, in principle, the same as the voltage of CK. If the motor generates capacitively reactive power to the power distribution network this means that the motor is overmagnetised, i.e. the rotor generates a counter-EMF in the stator winding that is higher than the voltage of the power distribution network. This overmagnetisation can be reduced by reducing the current in the rotor winding.

According to the invention this is achieved by reducing the phase angle between the two converter portions, however still using full PWM modulation, i.e. a maximum amplitude on each sine curve. The sinusoidal voltage over the rotor winding will then be reduced, and the current through the rotor winding will thereby also be reduced. The reduced rotor current has as result that magnetisation of the rotor is reduced. A lower current through the rotor winding has as result that the generated counter-EMF towards the power distribution network in the stator is reduced. If the phase angle between the converter portions are reduced to such extent that the generated counter-EMF in the stator equals the voltage of the power distribution network, the power distribution network will not be loaded by any reactive power, i.e. cos Φ=1. If the phase angle between the converter portions is reduced further, the motor will be under magnetised since the generated counter-EMF in the stator will be lower than the voltage of the power distribution network, with the result that the motor imposes a reactive inductive power load on the power distribution network.

Changing the phase angle between the converter portions thus provides a way of controlling the current through the rotor winding. Since the voltage over the capacitor CK will be a voltage that is determined by the flux wave generated by the stator, and the phase angle between the voltages being generated by the converter portions, the current through the rotor windings can be reduced by a phase angle change of the voltages being supplied to the ends of the rotor phase windings.

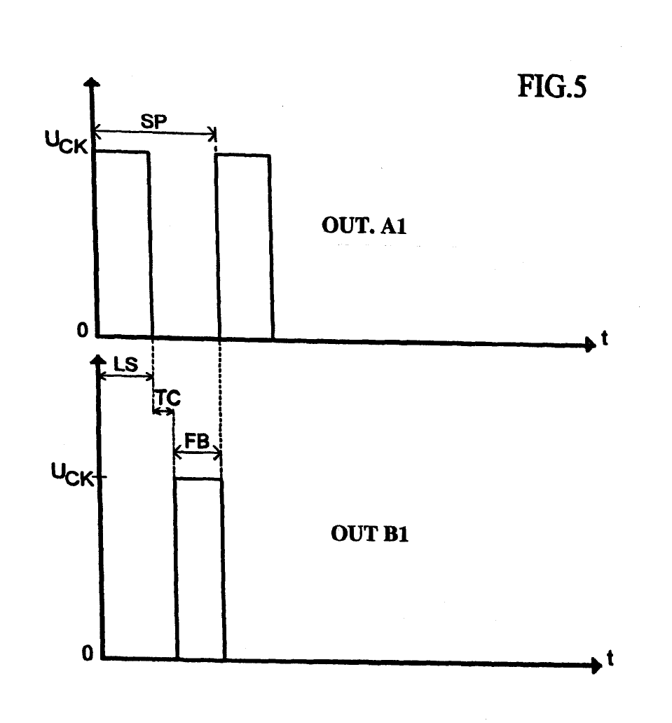

When the phase angle is reduced the voltage over the capacitor CK tends to rise due to (reactive) feed back through the diodes D1-D12. Therefore, for practical reasons, it can be necessary to limit the voltage over CK. This can, for example, be achieved by changing the appearance of the switch curve according to FIG. 5.

FIG. 5 shows a small portion of the PWM pattern for one phase that generates the desired sinusoidal shape, where shadowed portions indicate that an output is “high”. The upper curve (one of the outputs from the dual frequency converter, e.g. A1) thus represents a portion of a normal PWM sequence that creates a sine curve. The lower curve shows how the other output (B1) from the dual frequency converter adapts the curve to the upper sine curve so that the times Ls, Tc and Fb are created. Ls is the time that the rotor phase winding RL1 is connected between the two converter outputs A1 och B1. Energy is supplied to the phase winding RL1 from the capacitor CK since corresponding electrical valves of the winding are conducting concurrently and “diametrically” (i.e. V1 and V8 are open). Tc is the time that the current in the rotor phase winding is circulating by itself since the ends of the winding are short circuited by the electrical valves (V2 och V8 being open). Fb is the time that the rotor phase winding can feed back its energy to the capacitor CK since the valves of the winding are conducting diametrically but in an opposite manner as compared to the situation during time Ls (i.e. V2 and V7 are open).

According to FIG. 5 both ends of the phase winding are thus allowed to be “high” and “low” at the same time during longer or shorter periods of time in a circulation mode Tc, where the voltage over the phase winding equals the voltage fall over the two valves that are conducting at the time. During this time the current in the rotor phase winding will circulate through the valves on the positive side or on the negative side without supplying power to, and thereby charging, CK. IN this situation the current in the phase winding will be reduced in a considerably slower manner as compared to the situation when the voltage over the phase winding equals the voltage over CK. Since the power consumption in the rotor circuit, mainly depending on the resistance in the rotor circuit, equals percents of the power consumed by the motor, the voltage over the capacitor CK will be quickly reduced if the winding is not allowed to feed back energy to CK.

The time that the phase windings are in circulation mode can, for example, be determined by the speed and load of the motor, which effects the charge of CK. The longer time the winding is in circulation mode the lesser the charge to capacitor CK. A reduced voltage over CK has as result that the motor will load the power distribution network with a reduced capacitive reactive current, and if the voltage over CK is reduced further the power distribution network will be loaded by an inductive reactive current. If the voltage over CK is reduced to a too large extent the motor will lose its capability to operate synchronously. The time that the windings are to be in circulation mode Tc can therefore be controlled by the VCO and thus depend on the circumstances under which the motor is operating. Rotor speed, motor load and power distribution network voltage constitute factors that can have an impact on the above. The appearance of the PWM pattern must also be taken into consideration so that a desired sinusoidal frequency is obtained.

In the case shown in FIG. 5, which consequently shows just a very small portion of the PWM pattern that generates the sinusoidally shaped current through the rotor phase windings (a rotor frequency period can, as was mentioned above, be made up from several thousand or many thousand switch periods, of which only 1-2 is shown in the figure), Tc constitutes approximately 60% of the off-times of the upper curve. The voltage over CK can be controlled by Tc becoming comparatively longer or shorter.

If Tc constitutes a larger portion of a period the phase winding will feed back less power to CK than if the portion was shorter. The power that will flow to or from the rotor is determined by the time that each rotor phase winding is connected over capacitor CK. This occurs each time the valves of the rotor phase winding are on in a diametrically manner and is given as time Ls in FIG. 5. As an example of this the valves V7 and V2 will connect the phase winding RL1 to the voltage that CK is charged to. If the valve V7 now closes and the valve V8 instead opens the current that has been built up in the phase winding will circulate through the valves V2 and V8 and the phase winding RL1, this is given as time Tc in FIG. 5. This current will be reduced in a comparatively slow manner since energy in the phase winding RL1 is only consumed by the resistance in RL1 and the voltage fall in the valves V2 and V8. The time remaining of the switch period Sp is given as Fb in FIG. 5. Fb is the time that the phase winding RL1 returns power to CK. The relative time portion of a switch pulse Sp for Ls, Fb and Tc according to FIG. 5 is controlled with respect to the operational conditions of the motor and with respect to variations in voltage of the power distribution network, the speed of the rotor and the load. In general the time portion of Fb will be increased and the time portion of Tc be decreased if the rotor speed is increased. The reason for this is that the rotor current being generated by the stator flux wave is reduced linearly to 0 volt when the electrical rotational frequency of the rotor becomes the same as the frequency of the stator.

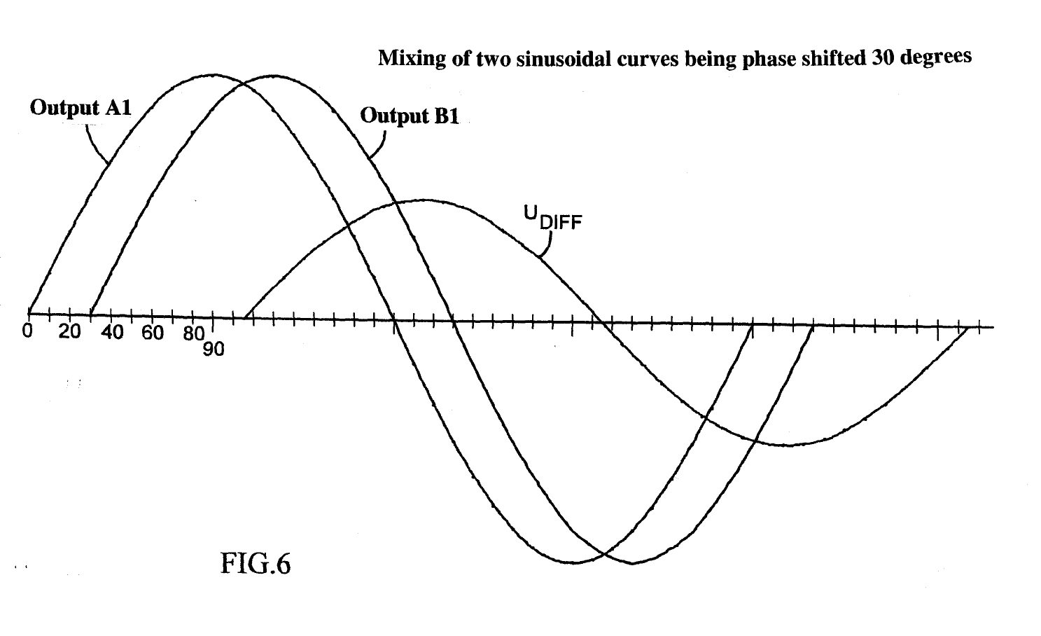

FIG. 6 shows voltage outputs from the dual frequency converter portions being connected to one side, respectively, of the phase winding RL1. The sinusoidal waves, being generated by PWM technology, are phase shifted approximately 30 degrees from each other which gives rise to a resulting voltage, Udiff, over the connected phase winding RL1. It is apparent from FIG. 6 that the two sine waves from the dual frequency converter at the respective ends of the phase winding are symmetrical. It is, of course, possible to allow the two waves that together feed a phase winding to have mutually different shapes.

In sum this means that the modulation of the PWM generated fundamental tone will determine the current through the rotor, and by means of this the cos Φ that the power distribution network is subjected to by the motor can be determined, since the proportion of the time that the phase windings are in circulation mode will effect the charge and thereby voltage over CK.

It is, of course, by means of programming possible to achieve that both output voltages from the dual converter 410 have circulation modes to a greater or lesser extent, and also to mutually different extents. The two curves at respective ends of a phase winding shall, however, give rise to a sinusoidally shaped current in the phase winding irrespective of the manner in which the control pulses from the VFO are generated by means of programming. A current having a modified sinusoidal shape can in some situations be generated if the mechanical appearance of the motor so require in order to compensate for this.

The present invention thus provides a possibility in choosing the manner in which the motor is to reactively load the power distribution network. If there is no reactive load of the power distribution network this is denoted as cos Φ=1. This is the operation mode that, in general, gives rise to the largest energy savings since no reactive current heats up the motor or causes any additional losses in the distribution lines. A reduced phase shift between the voltages that have been generated by the frequency converter portions, or a lower rotor current, has, however the result that the torque angle of the motor becomes larger. The torque angle of the motor is the angle that arises when the electromagnetic pulse created by the flux waves in rotor and stator separates from each other when the motor shaft is subjected to a load. If these come too far apart they will loose each other's “grip” and the motor will no longer run synchronously with the difference between stator frequency and rotor frequency. If the load of the motor shaft increases, the current through the rotor winding must therefore increase so that the torque angle does not become so large that there is a risk that the motor loses its synchronism.

The motor according to the above description can be speed controlled by changing the frequency of the converter while the cos Φ that the motor is subjecting the power distribution network to can be changed by changing the current through the rotor winding. In this manner the present invention provides a three-phase motor that fulfils all requirements that an economic and energy efficient motor should fulfil.

It is easy to obtain a unit that can be positioned on the motor shaft and/or rotor and that can be arranged to rotate with the rotor since the device according to FIG. 4 does not comprise any space-requiring components.

The present invention thus allows that a motor assembly consisting of motor and converter can be manufactured at a lower cost and with better performance that can be obtained by earlier solutions since the frequency converter is galvanically separated from the power distribution network, which reduces undesired transfer of harmonics and radio distortions to the power distribution network and which thereby also reduces the filter demand. In this way a very compact and cost efficient solution can be obtained. The motor can also provide substantial energy savings as compared to prior art solutions.

Instead of having a control logic according to the present invention being connected to the rotor and/or rotor shaft it can also be positioned outside the motor, e.g. on a drive shaft of an application being connected to the rotor shaft so that the control device still is arranged to rotate with the rotor.

The control logic can also be arranged to always be generating a certain rotor frequency by means of the frequency converter. No information from the outside needs to be transferred to the control logic, at least for as long as it can be ascertained that the load will not exceed a certain maximum load. The control logic, however, is advantageously arranged such that the rotor frequency of the voltage being generated by the frequency converter is controllable, e.g. based on a position sensor according to the above. In many situations, however, it is desired that the speed of the motor can be controlled on the basis of external factors, such as, for example, temperature of the surroundings in the case of a cooling fan. These control signals are often generated by stationary, i.e. non-rotary units, to which e.g. temperature sensors are connected. In such situations the control logic can advantageously be provided with means for wireless communication with such units so as to receive control signals from the non-rotating unit regarding desired motor speed/rotation frequency. This communication can advantageously be arranged to be carried out by means of a suitable wireless interface such as, but not limited to, optical transmission, IR, Bluetooth, WLAN or other radio technology, acoustic or magnetic transfer, in order to avoid problems with the transmission of control signals from a stationary source to the control logic rotating with the rotor.

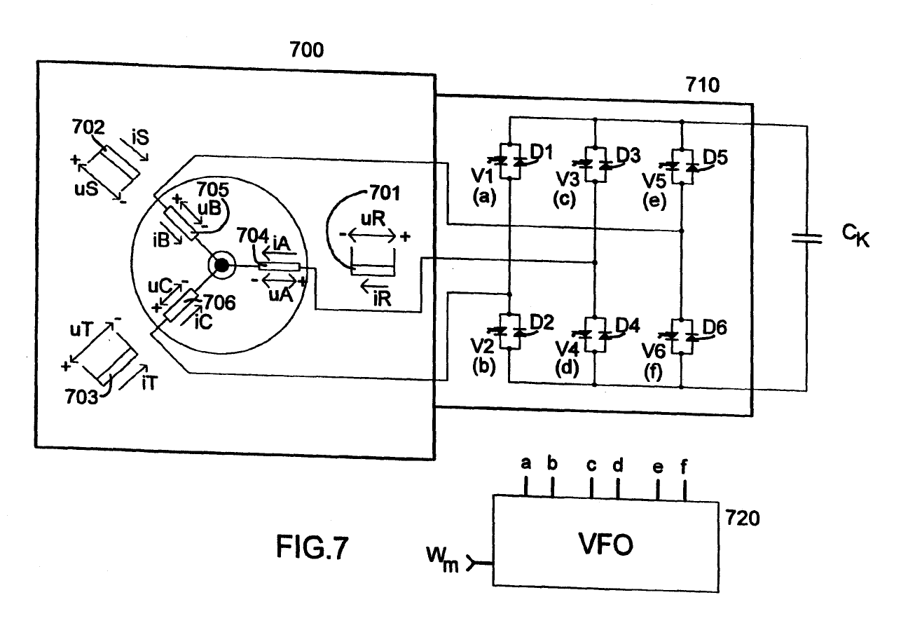

In FIG. 7 is shown an alternative exemplary embodiment of the invention. In the figure is schematically shown a 2-pole three-phase motor 700 of the same kind as the one shown in FIG. 4.

Instead of using a dual frequency converter according to the above, a (single) frequency converter 710, similar to the one shown in FIG. 1, is used in this embodiment and which consists of six electrical valves V1-V6, such as, e.g., IGBT-transistors and anti-parallel diodes D1-D6 associated therewith, the converter being connected to the rotor phase windings 704-706. The rotor phase winding voltages being induced by the stator winding generates, similar to the above, a direct voltage over the capacitor CK via the anti-parallel diodes D1-D6.

The frequency converter 710 then converts, by means of the valves, the direct-current voltage over the capacity CK to a three-phase alternating voltage, the frequency of which being settable by means of the control electronic VFO 720, e.g. by means of PWM in a known manner.

The six electrical valves V1-V6 receives, similar to what has been described with connection to FIG. 1, the control pulses from a controllable control oscillator VFO 720, whereby control pulses a, b, c, d, e, f from VFO opens and/or closes the electrical valves in a desired manner.

This embodiment thus differs from the one shown in FIG. 5 by the fact that the alternating voltage generated by the frequency converter 710 is only supplied to one end of the rotor phase windings. The rotor will, however, still rotate with a speed that corresponds to the difference between the power distribution network frequency and the rotor frequency that has been generated by the frequency converter 710.

Similar to the above the motor, if running with a constant speed, can be maximally braked by a certain torque if continued synchronous operation is to be maintained. This can, however, be ensured by using a position sensor according to the above. Consequently, this embodiment, too, exhibits the advantage that a three-phase motor can be speed controlled in a simple manner, where the components being required for the speed control can be integrated with a rotor and/or rotor shaft and where, due to the motor working in synchronous operation, surplus power can be fed back to the power distribution network. The embodiment shown in FIG. 7 has a cos Φ that in a loaded state is less favourable and which cannot be controlled in the same manner as in the embodiment shown in FIG. 4.

Instead of utilizing IGBT transistors as valves, any other suitable valve can be used, of course, such as, e.g. MOSFET transistors. In certain kinds of transistors, e.g. MOSFET transistors, the anti-parallel diodes are integrated with the transistors, in which case not external anti-parallel diode is required.

So far the present invention has principally been described in connection with a system wherein the frequency of the power distribution network is 50 Hz. The present invention, however, is applicable for power distribution networks having an arbitrary frequency.

Further, the invention has been described in connection with three-phase motors above. The three-phase motor has many advantages, e.g. that a flux wave having a substantially constant amplitude is obtained. In many situations, however, three-phase power supply is not available, for which reason use of a conventional three-phase motor not possible. The present invention, however, is also applicable for motors being intended for other power supplies than three-phase power supplies. For example, a motor having a stator being arranged for connection to a single-phase power distribution network can be used, i.e. a motor wherein the stator is wound for single-phase use.

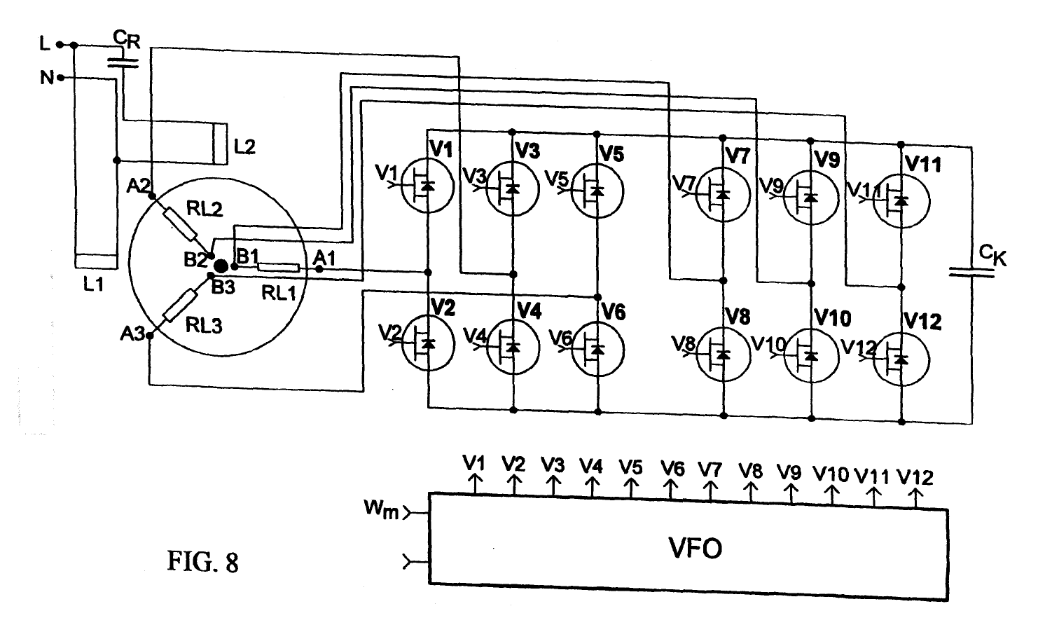

This is exemplified in FIG. 8. The stator of the motor shown in FIG. 8 is a stator for connection to a singe-phase power distribution network and has a phase winding L1 that constitutes the main winding of the stator and is connected to the single-phase distribution network N-L. The disclosed motor also comprises, as often is the case with regard to single-phase motors, an auxiliary winding L2 that is fed via an auxiliary phase that is generated by phase shifting the voltage of the power distribution network by means of a conventional capacitor or other reactive element.

The auxiliary winding is required to ensure that the motor can start, and this winding is series connected with a reactive element Cr that, in this case, is a capacitor. The current in the winding L2 is phase shifted in relation to the current in the winding L1. This phase shift of the currents gives rise to a rotating torque, which allows start of a motor that is standing still. The auxiliary winding can also provide a torque contribution in normal operation, whereby the capacitor Cr is constituted by a conventional running capacitor. The dimensioning of the windings and reactive elements for these windings follows the same computational methods as are used for inductions motors today.

The disclosed rotor winding is, similar to the above, a three-phase wound rotor having three phase windings, whereby the stator winding generates a flux in the stator and the rotor. This flux gives rise to a voltage over the capacitor CK. A rotating three-phase field is then generated, by means of the converter, whereby a torque arises that strives to rotate the rotor. The rotor will then rotate synchronous with the frequency difference between the rotational frequency of the stator field and the rotational frequency of the generated rotor field. Consequently, and single-phase motors, also, can thus be speed controlled by means of the present invention. Since this motor, too, operates in a synchronous manner, power can be fed back to the power distribution network that feeds the motor. Alternatively, the motor can be used as generator in order to generate electric energy for feeding a power distribution network being connected to the stator.

With regard to the above embodiments, the stator and rotor can, in general, be wound for different pole numbers. The motor according to the invention can also be power supplied by an arbitrary number of phases from a power distribution network, where the rotor can driven by an arbitrary number of phases from the converter.

Although the invention has been exemplified by a device that is arranged for being positioned on the motor shaft, and/or rotor and/or on a load being connected to the rotor to thereby avoid galvanic contact between rotating and non-rotating parts, it is also possible to use the present invention in a slip ring solution so as to have the converter arranged in a stationary manner. Such a solution would, in principle, function in the same manner, since the voltage being generated by the frequency converter, in this case, is generated by rotor voltage being taken out via the slip rings and is then supplied to the rotor winding via the slip rings. Such a solution can, e.g., be of interest for existing slip ring motors and large motors. Feed back to a power distribution network is still carried out by means of the stator, so the other advantages of the present invention is obtained by this solution also.

Further, the subject-matter that has been disclosed in the present description and the appended drawings is to be interpreted in an illustrative and non-limiting manner, the invention also relates to variations, modifications, and alterations of the above that are within the scope comprised by the appended claims.

1. A device for controlling the speed of an electric motor, wherein the said electric motor is arranged to be connected to a voltage source, wherein the said motor comprises a stator winding and a rotor winding, wherein, in operation, a rotating stator field having a first rotational frequency is generated in the stator winding, wherein the said stator field, in operation, is arranged to induce a first rotor field having a second rotational frequency in the said rotor winding, characterised in that the device comprises:
frequency converter means for generating a second rotor voltage having a third rotational frequency from a voltage being induced from the said stator field in the rotor winding, for being supplied to the said rotor winding.

2. Device according to claim 1, characterised in that the said frequency converter means comprises means for generating a first and a second alternating voltage, the said first alternating voltage being intended to be supplied to one end of the rotor winding, and the said second alternating voltage being intended to be fed to the second end of the rotor winding.

3. Device according to claim 1, characterised in that the said voltage source is a three-phase voltage source.

4. Device according to claim 1, characterised in that the said rotor winding is a three-phase rotor winding.

5. Device according to claim 1, characterised in that a second rotor field being generated, in operation, by the said second rotor voltage consists of a rotor field rotating in the same direction as the said stator field and/or the said first rotor field.

6. Device according to claim 1, characterised in that the said second rotor voltage being generated by the frequency converter means is a three-phase voltage.

7. Device according to claim 2, characterised in that it further comprises means for controlling the load of reactive energy that the motor imposes on a feeding power distribution network, whereby the size and value of the reactive energy can be controlled by varying the appearance of the said voltages being generated by the frequency converter.

8. Device according to claim 1, characterised in that it further comprises:
rectifier for rectifying a voltage being induced in the said rotor winding by means of the said stator field, and
a dual frequency converter for generating the said voltages for being supplied to the said rotor winding.

9. Device according to claim 8, characterised in that the said frequency converter comprises controllable valves, the said valves being arranged to be controlled by means of a control means.

10. Device according to claim 8, characterised in that the said dual frequency converter comprises electrical valves being pair wise connected to respective ends of the said rotor winding.

11. Device according to claim 1, wherein the said frequency converter is arranged to be controlled according to a position sensor being arranged for determining the position of the rotor in relation to the stator.

12. Device according to claim 9, characterised in that the said control means is arranged to be power supplied by means of a voltage being delivered from the said rotor winding.

13. Device according to claim 8, characterised in that the said rectifier consists of anti-parallel diodes respectively being connected to a respective valve, wherein a capacitor is arranged to be charged by means of the said rectified voltage.

14. Device according to claim 1, characterised in that the said electric motor is a three-phase motor.

15. Device according to claim 1, characterised in that the said device is arranged to be fastened to the said rotor and/or a shaft of the said motor and/or a load that, in operation, is connected to and rotated by the said motor so that the said device is arranged to, in operation, rotate with the said rotor.

16. Device according to claim 1, characterised in that it further is arranged to generate the said second rotor voltage for being supplied to the said rotor winding so that the said third frequency is lower than or equal to the said second frequency.

17. Device according to claim 1, characterised in that the said second rotor voltage being generated by the said frequency converter, in operation, generates a second rotating rotor field in the said rotor winding having a rotational direction being opposite to the rotational direction of the said first rotor field.

18. Device according to claim 1, characterised in that the said second rotational frequency is substantially the same as the said first rotational frequency.

19. Device according to claim 13, characterised in that the said capacitor is further arranged to be power supplied from an external source as well.

20. A method for controlling the speed of an electric motor, wherein the said motor is arranged to be connected to a voltage source, wherein the said motor comprises a stator winding and a rotor winding, wherein, in operation, a rotating stator field having a first rotational frequency is generated in the stator winding, wherein the said stator field, in operation, is arranged to induce a first rotor field having a first rotational frequency in the said rotor winding, characterised in that the method comprises the step of, in operation:
generating a second rotor voltage having a third rotational frequency for being supplied to the said rotor winding from a voltage in the rotor winding being induced by the said stator field, wherein the said generated second rotor voltage, in operation, generates a second rotating rotor field in the said rotor winding so that, in operation, the rotor rotates with a rotational frequency substantially being the difference between the rotational frequency of the stator field and the rotational frequency of the generated second rotor field.

21. An electric motor, wherein the said electric motor is arranged to be connected to a voltage source, and comprising a stator winding and a rotor winding, wherein, in operation, a rotating stator field having a first rotational frequency is generated in the stator winding, wherein the said stator field, in operation, is arranged to induce a first rotor field having a second rotational frequency in the said rotor winding, characterised in that the motor comprises:
frequency converter means for generating a second rotor voltage having a third rotational frequency from a voltage in the rotor winding being induced by the said stator field, for being supplied to the said rotor winding.

22. A generator, wherein the said generator is arranged to be connected to a power distribution network, comprising a stator winding and a rotor winding, wherein in the rotor winding, in operation, a rotating rotor field having a second rotational frequency is generated, characterised in that the generator comprises:
frequency converter means for generating a second rotor voltage having a third rotational frequency from a voltage in the rotor winding being induced by rotation of the rotor, for being supplied to the said rotor winding, wherein the said generated second rotor voltage being generated by the said frequency converter, in operation, generates a second rotating rotor field in the said rotor winding so that, in operation, the stator field rotates with a rotational frequency substantially being the sum of the rotational frequency of the rotor and the rotational frequency of the generated second rotor field.

23. A generator according to claim 22, characterised in that the said second rotor field being generated, in operation, by the said frequency converter, generates a rotor field having a rotational direction being opposite to the rotational direction of the said first rotor field.
